(19) United States
(12) Patent Application Publication
(10) Pub. No.: US 2009/0200219 A1
(43) Pub. Date: Aug. 13, 2009

(54) Apparatus for removing impurity in oil using air cooler

(76) Inventor: Seung Woo Lee, Suwon (KR)

Correspondence Address: Thomas M. Galgano, 20 W. Park Avenue, Suite 204, Long Beach, NY, 11561, US

(21) Appl. No.: 11/663,786

(22) PCT Filed: Aug. 23, 2005
(86) PCT No.: PCT/KR05/02776

§ 371 Date: Mar. 23, 2007

(30) Foreign Application Priority Data
Aug. 24, 2004 (KR) 10-2004-0066938

(51) Int. Cl. B01D 17/035

(52) U.S. Cl. 210/209

(57) ABSTRACT

An air cooler type apparatus of removing impurities from oil is disclosed. The air cooler type apparatus of removing impurities from oil comprises: a body having an enclosed space for storing oil; a cool air injecting portion formed at a upper portion of the body and for injecting an air, which is cooled at a predetermined temperature corresponding to a temperature of the oil stored in the body, into an inside of the body; an absorption means mounted on a supporting structure of absorption means mounted to a lower portion of the body and for absorbing the impurities, which are deposited by descending a temperature owing to the injected air through the cool air injecting portion; a separating and discharging portion formed at one side of the body and above the absorption means and for separating and collecting the oil, in which the impurity is removed; and an impurity discharging portion formed at a lower end portion of the body and for discharging the impurity, which is deposited by descending temperature owing to the injected air through the cool air injecting portion and is not absorbed in the absorption means, to an outside thereof.

### TECHNICAL FIELD

The present invention relates generally to an air cooler type apparatus of removing impurities from oil.

### BACKGROUND ART

At present, in order to remove impurities contained in the oil, as shown in FIG. 1, there is a general method in that the oil passes through a paper or a cartridge made of cotton fabrics to remove the impurities.

In the conventional method, when the oil coming in through an oil inlet pipe 100A flows into the cartridge for changing, the oil passes through small holes of the cartridge and flows to outside through a discharge pipe 150. Accordingly, there is a merit in that the operations is convenient.

However, besides the impurity having big particles, the remaining external materials, in which fine waterdrops (H₂O), particle materials (PM), sulfur or the like are mixed with each other, are existed in the oil. As shown in FIG. 1, since the remaining external materials, such as the fine waterdrops, particle materials, sulfur and so on, are not separated from the oil satisfactorily through the oil cartridge of a single shape, lots of impurities is floating on the oil.

The basic reason why exhaust gas is generated by the oil is because that a mixture (impurities), such as water (H₂O), particle materials (PM), sulfur or the like, including a group of very small waterdrops, which are mixed with car fuel in high concentration, continually flows into an internal-combustion engine (cylinder), whereby it brings about imperfect combustion.

Especially, the water, which is mixed with the oil, causes precision parts of fuel supply apparatus and spray for car to corrode, so that the life span of car is shorten. Also, since the water is evaporated and takes a plenty of energy away from the engine when the mixed gas is exploded in the internal-combustion engine, the combustion goes bad and a plenty of smoke is generated.

Accordingly, a demand for an apparatus of removing the remaining impurities contained in the oil and decreasing the exhaust gas has been increased.

### DISCLOSURE OF INVENTION

### Technical Problem

Accordingly, the present invention has been made to solve the above-mentioned problems occurring in the prior art, and an object of the present invention is to provide an air cooler type apparatus of removing impurities from oil in which water (H₂O), particle materials (PM), sulfur (s) or the like, which are unnecessary mixture in oil, are separated and removed from the oil to furnish oil of high quality, whereby the exhaust gas can be remarkably decreased.

### Technical Solution

To accomplish this object, the present invention provides an air cooler type apparatus of removing impurities from oil comprising: a body having an enclosed space for storing oil; a cool air injecting portion formed at a upper portion of the body and for injecting an air, which is cooled at a predetermined temperature corresponding to a temperature of the oil stored in the body, into an inside of the body; an absorption means mounted on a supporting structure of absorption means mounted to a lower portion of the body and for absorbing the impurity, which is deposited by descending temperature owing to the injected air through the cool air injecting portion; a separating and discharging portion formed at one side of the body and above the absorption means and for separating and collecting the oil, in which the impurity is removed; and an impurity discharging portion formed at a lower end portion of the body and for discharging the impurity, which is deposited by descending temperature owing to the injected air through the cool air injecting portion and is not absorbed in the absorption means, to an outside thereof.

According to the air cooler type apparatus of removing impurities from oil of the present invention, the apparatus further comprises an underground oil settling tank connected to one side of the body through a coupling pipe, wherein the oil is deposited in the settling tank for a predetermined time and flows into the body.

According to the air cooler type apparatus of removing impurities from oil of the present invention, the apparatus further comprises a grating portion mounted between the a separating and discharging portion and the absorption means and an oil injecting portion for washing located at the upper portion of the body and for injecting the oil for washing into the inside of the body, wherein an outer surface of the body is packed with a material for keeping coolness in order to be insulated from an outside thereof.

According to the air cooler type apparatus of removing impurities from oil of the present invention, the air of the cool air injecting portion filtered below 30% in humidity is cooled at 1° C.-5° C. and is injected into the inside of the body for 6-12 hours.

### ADVANTAGEOUS EFFECTS

The present invention has an advantage in that water (H₂O), particle materials (PM), sulfur (s) or the like, which are unnecessary mixture in oil, are separated and removed from the oil to furnish oil of high quality, whereby the exhaust gas can be remarkably decreased.

Namely, where oil of high cleanness and high purity is used in the internal-combustion engine by using the air cooler type apparatus of removing impurities from oil, the ignition becomes better and the perfect combustion is accomplished in the internal-combustion engine, so that the occurrence of exhaust gas is remarkably decreased.

The present invention has another advantage in that capacity of the engine and fuel efficiency is improved, thereby economizing in oil, the supply of the oil is smooth without being blocked on account of impurities in the engine, and the life span of main parts of fuel supply apparatus and spray for car is extended.

### BRIEF DESCRIPTION OF THE DRAWINGS

The above as well as the other objects, features and advantages of the present invention will be more apparent from the following detailed description taken in conjunction with the accompanying drawings, in which:

FIG. 1 is a sectional view of a oil cartridge illustrate a conventional method of removing impurities from oil;

FIG. 2 is a perspective view illustrating a mounting state of an underground oil settling tank and an air cooler type apparatus of removing impurities according to the present invention;

FIG. 3 is a sectional view illustrating a body of the air cooler type apparatus of removing impurities;

FIG. 4 is a perspective view illustrating a detailed structure of a grating portion of FIG. 3;

FIG. 5 is a perspective view illustrating a detailed structure of a supporting structure of an absorption means of FIG. 3;

FIG. 6 is a report on measured test results of a water and a sulfur in regard to a light oil, in which impurities is removed, according to the present invention;

FIG. 7 is a report on measured test results of a NAS contamination in regard to a light oil, in which impurities is removed, according to the present invention; and

FIG. 8 is a table on close test results of a car oiling light oil, in which impurities is removed, according to the present invention.

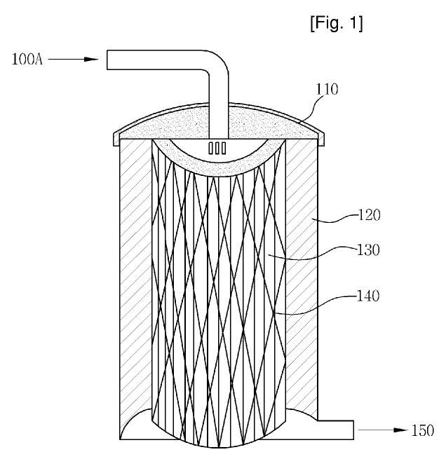

### BEST MODE FOR CARRYING OUT THE INVENTION

Generally, since oil is smaller than water in terms of a specific gravity, where the oil contains the water in an oil tank, it is thought that the water goes to the bottom thereof and does not flow into the outside. However, contrary to this thought, the water and many impurities are actually floating in the oil.

In summer that oil has a most high water content, after the oil, such as gasoline or light oil and so on, puts into a transparent vessel, when it observes the oil through a magnifying glass and so forth, it finds an infinitude of very small waterdrops and a plenty of particles floating into the oil. In this way, the water contained into the oil includes a group of very small waterdrops, which can be mixed with the oil well. Also, the oil containing the water is diluted and then, takes goods out of the oil refinery.

That is, where general water puts into the oil, the water goes to the bottom. Also, as though it shakes a water bottle containing the oil, the water goes to the bottom of the bottle and is not diluted with the oil. The water molecule is combined among the same one tightly.

Generally, exhaust gas of an oil car is decreased in winter of a low temperature. On the other hand, exhaust gas of an oil car is increased sharply in summer of a high temperature on account of the increasing of a pollutant in the oil.

The applicant detected monthly exhaust gas degrees from his own car.

Measured test results of exhaust gas using his own car

Table on test results of exhaust gas measured by using a light oil on market through year

Test place: Suwon-city, Korea

TABLE 1

| | |
|---|---|
| Jan. 24, 2003 | Oiling at Hongbo gas station(26.8% on the average of three times) |
| Feb. 18, 2003 | Oiling at Hongbo gas station(34.0% on the average of three times) |
| Mar. 17, 2003 | Oiling at Hongbo gas station(25.5% on the average of three |
| | times)(Hongbo gas station has been changed into a designated |
| | business office of bio-diesel, so that the density of exhaust gas is |
| | slightly decreased) |
| Apr. 16, 2003 | Oiling at Hyundae gas station(30.7% on the average of three times) |
| May 19, 2003 | Oiling at Hyundae gas station(32.0% on the average of three times) |
| Jun. 16, 2003 | Oiling at Hyundae gas station(36.0% on the average of three times) |
| Jul. 16, 2002 | Oiling at Hongbo gas station(50.0% on the average of three times) |
| Jul. 30, 2002 | Oiling at Hongbo gas station(58.3% on the average of three times) |
| Sep. 13, 2002 | Oiling at Hongbo gas station(35.7% on the average of three times) |
| Nov. 21, 2002 | Oiling at Hongbo gas station(30.1% on the average of three times) |
| Dec. 06, 2002 | Oiling at Hongbo gas station(29.0% on the average of three times) |

The first test date of exhaust gas was Jul. 16, 2002.

From the above measuring values, it can be found that the exhaust gas degrees from June to September (summer season) are highest throughout the yeas.

In order to find out the reason for changing the production amount of exhaust gas according to the season as described above, the applicant makes an experiment with light oil producing a plenty of exhaust gas among oil, as follows.

1. Separation of Oil and Water

First of all, after light oil is injected into a plural of transparent plastic bottles of 5 L, each plastic bottle is sealed and is frozen in an air cooler type refrigerator of −20 C for 48 hours. In this case, where light oil is frozen, small waterdrops floating in light oil are combined with each other and go to the bottom of the bottle to be frozen.

After refrigeration, it removes a frost forming the outer surface of the bottle and stirs the light oil turned into cream with a stick to be watery (here, the light oil, which is not turned into cream, is used as it is). Thereafter, a large funnel is inserted into a spring water bottle of 20 L and it filters the refrigerated light oil through a fine household sieve.

Where the light oil is all filtered, ice grains, such as a hail are left over in the sieve. Here, the ice grains are putted into a white PVC vessel to be melted. The refrigerated water, which is in the formed of ice grains in the oil, exists roundly or long in the bottom of the oil layer and does not mixed with the light oil.

As though the confirmed water mount is very small, it can be seen that the shape of the water moving roundly is different from that of the light oil.

Only a waterdrop is gathered in a transparent water bottle, after the removing of the light oil. Thereafter, the light oil and water mix in the rate of approximately ten to one and it prepares an oil-water mixed liquid of about 60 cc.

It will observe a state variation of the oil-water mixed liquid according to temperature variation and look around the activities and existence of the water mixed in the light oil according to the season herein below.

2. Variation Table of Light Oil-Water Mixed Liquid by Temperature

TABLE 2

| Temperature of | |
|---|---|
| light oil-water | A change of status after gas bubbles rise from by shaking the light |
| mixed liquid | oil-water mixed liquid |
| −10° C. | Light oil is hazy in color and is turned into a thick cream after 40 |
| | minutes. Water below oil layer is frozen. |
| 2° C. | L&H solution is hazy in color on the whole |
| 5° C. | 1. Waterdrops rapidly sink to lower part while being mixed with |
| | mutually. Water completely sinks to the bottom of the oil layer. |
| | As though it shakes the vessel, the water molecules are tightly |
| | combined with each other and remain stationary. 2. Oil is not |
| | mixed with water in low temperature. |
| 10° C. | It is similar to 5° C. However, time, in that water stays with oil |
| | layer, becomes longer. Water is mixed with oil and they sink to |
| | bottom in about 30 seconds. |
| 12° C. | Time, in that waterdrops stay with oil layer, becomes |
| | longer. Waterdrops completely sink to bottom in about 30 minutes |
| | to maintain a steady state. |
| 20° C. | 1. Parts of waterdrops do not sink to bottom and continually float |
| | on oil layer as though time over 30 minutes has passed. When it |
| | observes the oil through the magnifying glass of five magnifications, |
| | it can find small watedrops floated. 2. When it slowly |
| | moves the vessel, water, which sinks to bottom, is soft and is |
| | divided into small shapes while spreading out throughout bottom |
| | surface. |
| 30° C. | When it slightly moves the vessel, water is divided into a group of |
| | very small waterdrops and continually spreads out throughout |
| | vessel. As temperature rises, since water and oil are completely |
| | mixed with each other, it is difficulty to distinguish between them |
| | and waterdrops are not deposited well. |

3. Concentration of Light Oil-Water Mixed Liquid

Where it puts a absorbent cotton into a transparent vessel containing the oil-water mixed liquid in a circle and body, the oil located at the upper portion of the vessel is rapidly absorbed into the absorbent cotton at the beginning. At this time, when the absorbent cotton is contacted with the water located at the lower portion of the vessel by using tweezers, the oil, which is lighter than the water, comes out of the absorbent cotton slowly and the water is absorbed into the spot.

After about ten minutes, when the water is absorbed into the absorbent cotton all together, it takes the absorbent cotton out of the vessel with tweezers and wrings out it. In this case, a dense liquid of a pale yellow flows out from the absorbent cotton and a charcoal dust (carbon powder) together with a deposit stick to the absorbent cotton in abundance.

The dense liquid of a pale yellow is a corporate body of small waterdrops, which are contacted with the oil in the airtight vessel of high temperature for a very long time, and causes the exhaust gas of cars.

Where the paper applying the liquid is burned, its incombustibility is very strong and smoke of an enormous quantity can be generated as an extreme small amount also.

4. Particle Material (PM)

Particle Material (PM) means a very small minute particle or a deposit and so on, which float in the oil. after the oil puts into a transparent vessel, when it observes the oil through the magnifying glass, it can find the particle materials of a small shape, which float in the oil innumerably.

A plenty of minute particles go to the bottom of the vessel as time goes by. The minute particles are well combined with water molecules to become heavy, in summer that oil has a high water content, so that the floating time of the minute particles is getting shorter. On the other hand, in winter that oil has a low water content, the minute particles are getting lighter, so that the minute particles do not sink and float on the oil for a long time.

The minute particles flow into an internal-combustion engine all together, so that it brings about imperfect combustion. Also, after combustion, the minute particles are discharged.

* Deposition Time of Particle Materials

TABLE 3

| | | Deposition | Deposition rate |
|---|---|---|---|
| | Temparature | Time | (with naked eye) |
| Winter | Below 12° C. | 75 hours | 50% |
| Summer | 30° C. | 55 hours | 90% |

5. Sulfur(S)

After the air cooler type apparatus according to the present invention is manufactured in the type of a small size and the impurity is removed from oil about ten times by using it, we can confirm that absorption means 27 has been colored yellow.

This phenomenon means that the sulfur as a simple substance of a free state is existed apart from the oil.

6. Analysis of the Experimental Result

As seen from the experimental result, in the oil-water mixed liquid, the water is not combined with the oil well below 12 C above zero. Also, as though it shakes the vessel strongly and gives the strength to the small waterdrops floating on the oil, the moving distance of the waterdrops is short and the waterdrops rapidly sink to the bottom of the oil layer while being mixed with mutually.

This phenomenon is due to a principle in that the substance changes a liquid state into a solid state when its temperature falls, whereby molecules are arranged regularly and electricity is generated from the substance.

In the small waterdrops having an electrical property in the oil of low temperature like this, the oil serves to transmit the electricity well, so that the attraction power acts on the small waterdrops, thereby the moving distance of the waterdrops is short and the waterdrops rapidly sink to the bottom of the oil layer on account of the mutual bonding and the increase in weight.

On the contrary, above 12° C., the electricity generated in the water molecule is disappeared, whereby the mutual attracting power is also disappeared. Therefore, the water is not combined with each other and divides into fine shapes to be light, so that the water is easily floated on oil and the floating time thereof becomes longer.

As stated above, in summer, imperfect combustion is generated in the internal-combustion engine of the light oil (diesel) car owing to the fine waterdrops (H₂O), particle materials (PM), and sulfur or the like, which are high-densely mixed in the oil, the amount of the exhaust gas of the light oil car is greatly increased.

Although there is more or less difference in experimental results, similar results are anticipated about another oil. Also, it is deduced that the amount of the exhaust gas is increased on account of water, particle materials (PM) and sulfur.

Reference will now be made in detail to the preferred embodiments of the present invention.

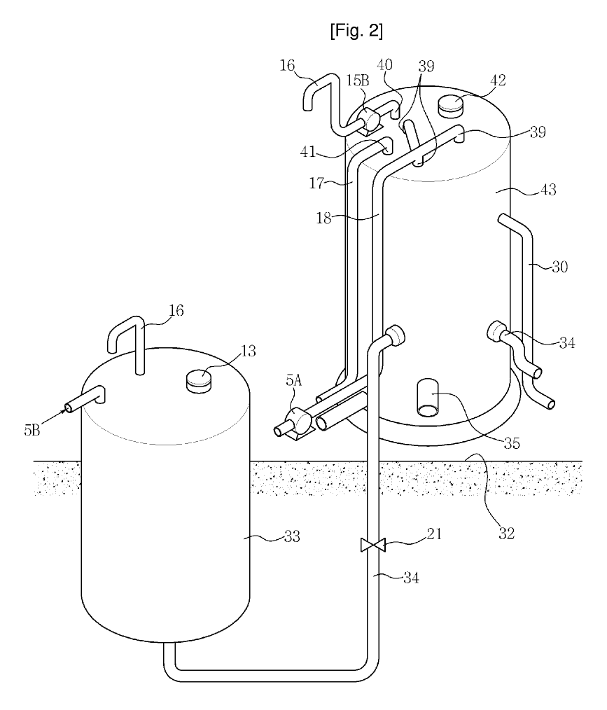

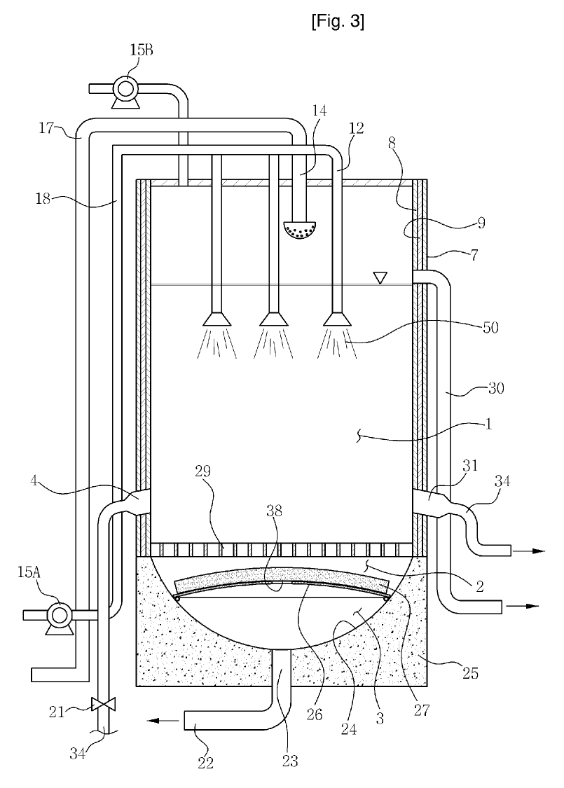

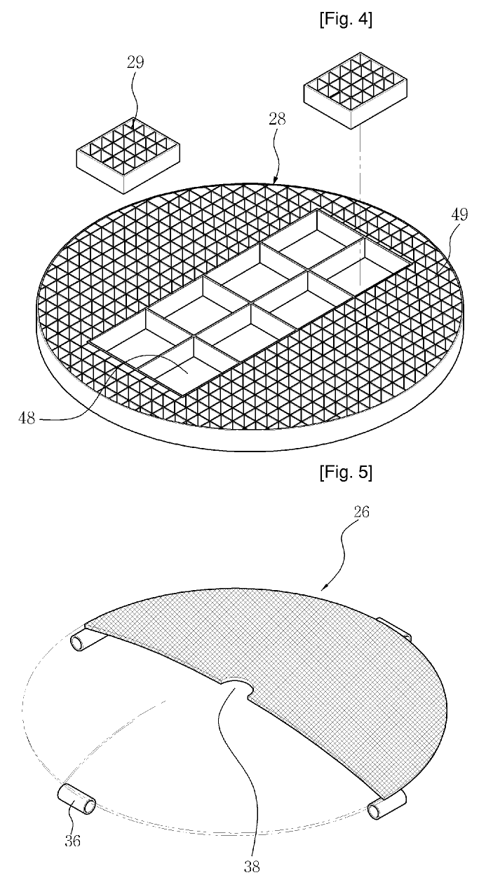

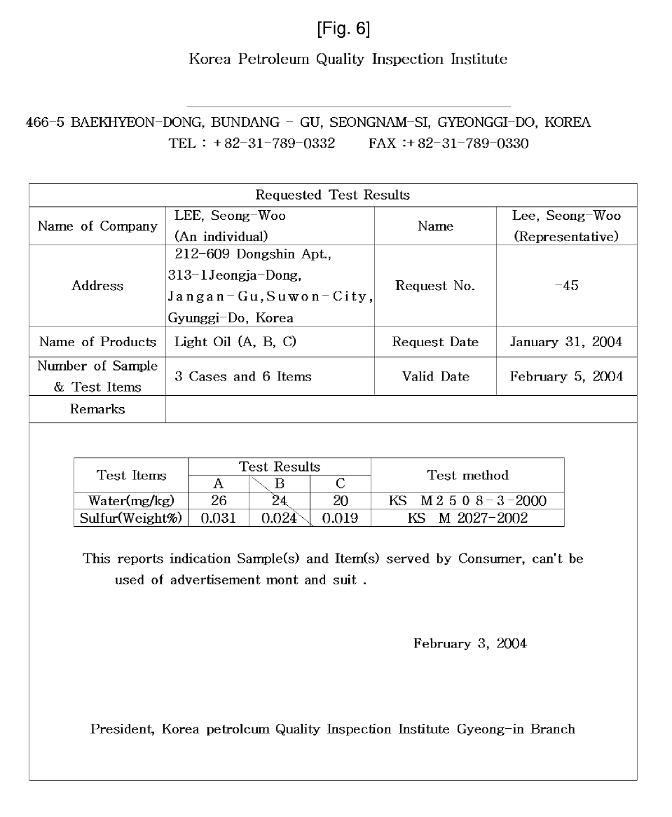

FIG. 2 is a perspective view illustrating a mounting state of an underground oil settling tank and an air cooler type apparatus of removing impurities according to the present invention, FIG. 3 is a sectional view illustrating a body of the air cooler type apparatus of removing impurities, FIG. 4 is a perspective view illustrating a detailed structure of a grating portion of FIG. 3, and FIG. 5 is a perspective view illustrating a detailed structure of a supporting structure of an absorption means of FIG. 3.

As shown in FIG. 2, the oil goes throw two processes in that the underground oil is deposited in the settling tank 33 for a predetermined time and flows into the body 43 of the air cooler type apparatus of removing impurities.

Where the underground oil is stored in the settling tank 33 for a predetermined time, after the particle materials (PM) completely waste kinetic energy thereof and sink to the lower portion, they are greatly combined with each other by means of oil pressure, thereby firstly removing the impurity. Parts of the particle materials (PM), which are not combined with each other, are secondly removed in the body 43 of the air cooler type apparatus of removing impurities.

The settling tank 33 serves to maintain the temperature suitable for removing impurities from the oil, besides the first filtering function. That is, in winter, the light oil is turned into a thick cream, so that it is difficulty to spray an air into the oil. On the contrary, in summer, the temperature of the oil is high, so that it is difficulty to transmit a cool air to the lower portion of the vessel. Therefore, where the oil is stored in the settling tank 33, the temperature of the oil is maintained within 10° C.-20° C. closely akin to 1° C.-12° C., which is optimum temperature for driving the air cooler type apparatus of removing impurities according to the present invention.

The body 43 of the air cooler type apparatus of removing impurities is constructed on the ground in order to be well ventilated and easily go in and out.

The body 43 of the air cooler type apparatus of removing impurities is connected to the settling tank 33 through a coupling pipe 34 including a check valve 21 for preventing flowing backward of the oil.

The oil supplied through the coupling pipe 34 is putted into the body 43 of the air cooler type apparatus through an oil inlet pipe 4. The oil inlet pipe 4 is larger than the coupling pipe 34 in the inside diameter and is slanted to the upper portion. The oil inlet pipe 4 serves to broadly spray the oil ascending in high pressure on the bottom and wash the impurities, which is located on the grating portion 28 and the absorption means 27.

The inside of the body 43 includes an upper room 1 located on the upper portion of the grating portion 28, a middle room 2 between the grating portion 28 and the supporting structure 26 of absorption means, and a lower 0room 3 between the lower portion of the supporting structure 26 of absorption means and a lower surface thereof.

A hall 39 for cool air inlet pipe, a hall 40 for air intake and exhaust pipe, and a hall 41 for washing, which are connected to a cool air inlet pipe 18, an air intake and exhaust pipe 16, and a coupling pipe 17 for high-pressure oil inlet, respectively, are formed on the top surface of the body 43. Also, a main gateway 42 is formed on the one side of the top surface of the body 43, so that a worker can go in and out.

One end of the cool air inlet pipe 18 is connected to an air blower 15A and the other end of the cool air inlet pipe 18 is connected to a plurality of air injecting portion 12, which is located at the upper portion of the inside of the body 43, so that the external cool air is supplied to the inside of the body 43.

The coupling pipe 17 for high-pressure oil inlet is connected to an injection nozzle 14, which is located at the upper portion of the inside of the body 43, so that the high-pressure oil for washing is supplied to the inside of the body 43.

An overflow pipe 30 is mounted on one side of an inner surface of the body 43, so that the overflowing oil re-flows into the settling tank 33.

An oil discharge pipe 31 is formed on one side of the inner surface of the body 43 corresponding to the oil inlet pipe 4, so that the high purity oil, in which the impurities are eliminated in the upper room 1, is discharged to the outside through another coupling pipe 34, which is connected with the oil discharge pipe 31. The oil discharge pipe 31 is larger than the coupling pipe 34 in the inside diameter and is slanted to the lower portion, so that the swirling oil does not flow into the middle room 2 and the lower room 3 in the course of oil discharge.

The grating portion 28 is located under the oil inlet pipe 4, so that the oil swirling phenomenon between the upper room 1 and the middle room 2 can be blocked in the course of oil discharge and it can prevent the impurities from floating on the upper room 1. As shown in FIG. 4, the grating portion 28 includes a detachable grating mounting space 48 at the center thereof and a fixed grating mounting space 49. A detachable grating 29 is mounted on the detachable grating mounting space 48 and serves as the entrance of worker in the course of repair operation or change of the absorption means 27.

As shown in FIG. 5, the supporting structure 26 of absorption means having a net shape is formed under the grating portion 28 and the absorption means 27, such as cotton fabrics or the like, is placed on the supporting structure 26 of absorption means. A plurality of supporting pipes 36 is mounted on the circumference surface of the supporting structure 26 of absorption means in the tangential direction, so that it can secure a space between the supporting structure 26 of absorption means and the inner surface of the body 43, thereby the class B oil or the impurities can descend to the lower room 3. The absorption means 27 serves to absorb and store the water and sulfur, which descend from the upper room 1, and adhere the particle materials, so as to prevent the impurities from descending to the lower room 3. A gateway 38 is formed at the center of the supporting structure 26 of absorption means, so that the worker can go in and out the lower room 3.

The body 43 is combined with an end plate 24 of a vessel shape, which is curved downward, to constitute a treatment area for removing the impurities of the oil. Also, a filter net 23 for filtering the impurities again is formed at the center of the bottom surface of the end plate 24, so that the class B oil passing through the filter net 23 is discharged to outside via a discharge pipe 22 of class B oil. The end plate 24 is made of a stainless for anti-rust. The end plate 24 is mounted on a concrete supporting structure 25 of absorption means having a shape corresponding to the lower shape of the end plate 24.

A material 9 for keeping coolness is inserted between an outer surface 8 of the body 43 and a body cover 7 in order to keep the inside of the body 43 in a low temperature.

An operation of the air cooler type apparatus of removing impurities according to the present invention will be described in detail hereinafter.

When the oil of 10° C.-20° C., in which the deposition of the minute particles is completed in the settling tank 33, flows into the inside of the body 43, the air, which is filtered below 30% in humidity through the dehumidifier (not shown) and air filter (not shown), is cooled at 1° C.-5° C. and the cool air is directly sprayed on the oil through the air blower 15B, the cool air inlet pipe 18 and the plurality of air injecting portion 12 for 6-12 hours.

Where the temperature of the oil for removing the impurities is about 20° C., the cool air of about 1° C. is sprayed downward. In the meantime, where the temperature of the oil for removing the impurities is below 15° C., the cool air of about 5° C. is sprayed downward.

When the cool air is sprayed, the cool air, which is heavier than the oil in humidity, is moved downward and the fine waterdrops floated on the upper room 1 and the middle room 2 are contacted with the cool air below 12° C., so that the fine waterdrops can be greatly combined with each other.

In the present invention, when the cool air of high pressure is sprayed toward the bottom of the lower room 3 from the upper portion of the oil layer, the impurities of the oil are quickly deposited by the following action.

1. The cool air serves to quickly transmit it to a specific material and quickly take heat away from the material of high temperature to become a low temperature.

2. The cool air is moved downward and contacted with the fine waterdrops or the like floated on the oil at a low temperature, so that the waterdrops are quickly cooled, thereby the water molecules losing its energy change a liquid state into a solid state. On this, water molecules are arranged regularly and electricity is generated from the waterdrops, so that the attraction power acts on the neighboring small waterdrops each other. Hence, the fine waterdrops are greatly combined with each other to be easily deposited.

3. The cool air sinks to lower portion and the fine waterdrops having electricity contained in the cool air are floated on the oil for many hours, so that the fine waterdrops are continually adhered to the surfaces of the minute particles (PM) or the sulfur and the like to increase the weight thereof, thereby being quickly deposited at the bottom of the oil layer.

By the above action, the impurities (the deposited materials) descend to the middle room 2 through the grating 29, which is located at the lower portion of the upper room 1, so that the water and the sulfur are absorbed into the absorption means 27 and parts thereof sink to the lower room 3 along the wall.

Also, the great changed particle materials quickly sink to the bottoms of the middle room 2 and lower room 3.

The oil left over the middle room 2 and lower room 3 is extracted to the outside by using the discharge pipe 22 and is separately filtered by an oil cartridge to come into the market as a general oil.

In washing process, the oil is supplied to the coupling pipe 17 for high-pressure oil inlet and it sprays the injection nozzle 14 on the oil, so that the contaminant left over each portion of the inside thereof is collected on the bottom of the lower room 3 to be extracted to the outside by using the discharge pipe 22.

The absorption means 27 located on the middle room 2 should be periodically replaced. The main gateway 42 and a ventilating opening 35 are opened and the air blower 15B is operated so as to change air. Then, the worker goes in the inside thereof through the main gateway 42 and opens the detachable grating 48. Thereafter, the worker goes down the middle room 2 and removes the fixed absorption means 27, and then moves the removed absorption means 27 to outside and washes the inside thereof.

FIG. 6 is a report on measured test results of a water and a sulfur in regard to a light oil, in which impurities is removed, according to the present invention. According to the report, it decreases from 26 ppm (light oil A) to 20 ppm in water. Also, it sharply decreases from 0.031% (light oil A) to 0.019% in sulfur.

In case of water, the water measurement is conducted at the times, in which the water content of the oil is comparatively little throughout the year. At a measurement point of time, since the amount of the water existing in the atmosphere is 20-30 ppm, the lowest value thereof is accomplished.

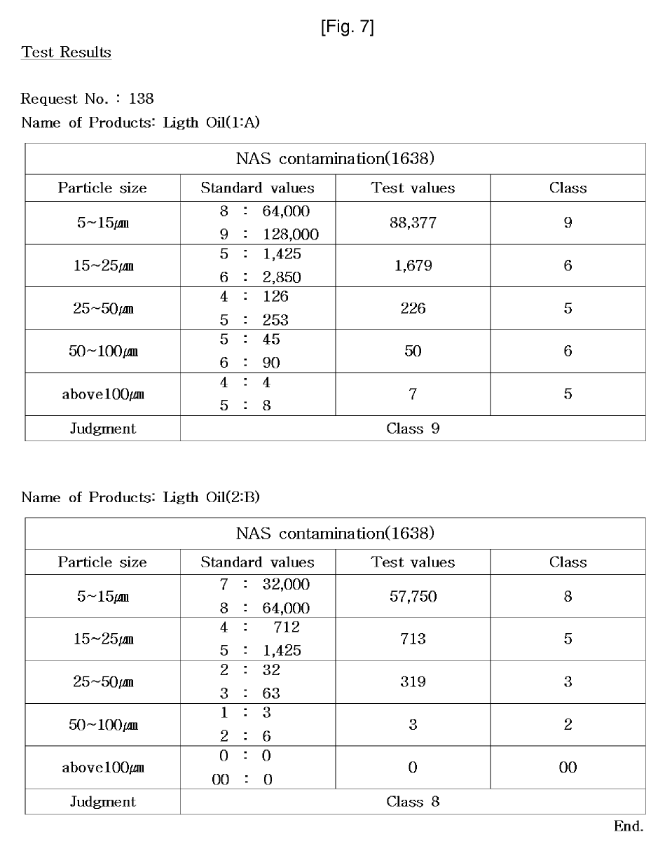

FIG. 7 is a report on measured test results of a NAS contamination in regard to a light oil, in which impurities is removed, according to the present invention. According to this report, it decreases from the class 9 (light oil A) to the class 8 (light oil B) in NAS contamination. Especially, in particle size above 100 mm, the particle material is not detected at all.

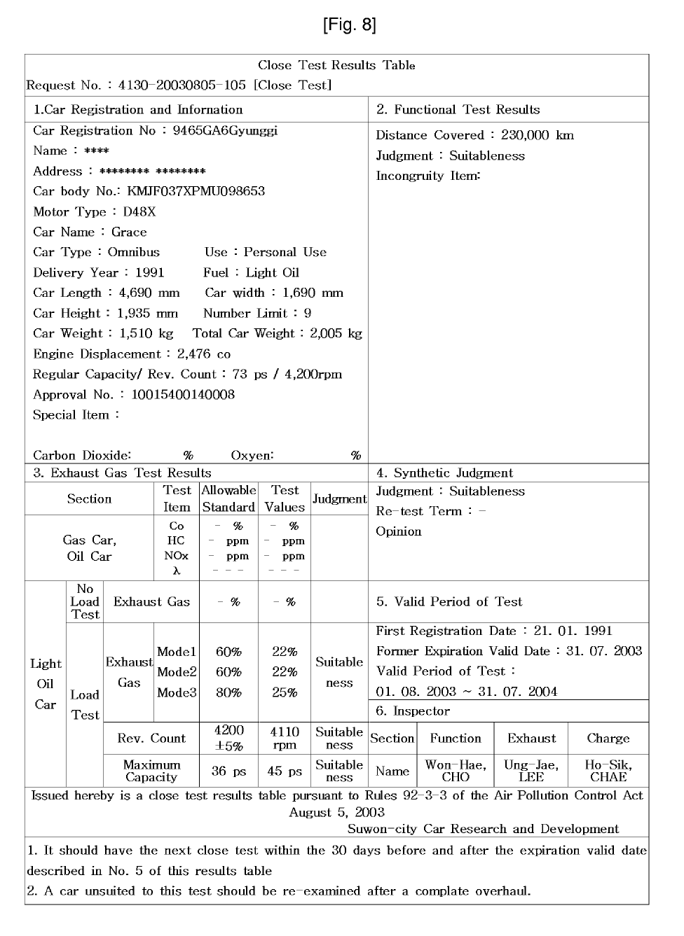

FIG. 8 is a table on close test results of a car oiling a light oil, in which impurities is removed, according to the present invention. The applicant oiled the light oil treated according to the present invention in his car (using for thirteen years) and the car was examined at KOTSA (Korea Transportation Safety Authority) in Aug. 5, 2003. The result of the exhaust gas discharge was 23% on the average of three times (permissible standard: 80%).

According to this table, a high capacity of 45 p.s. is outputted at 4110 rpm in comparison with an allowable standard (38 p.s.: 4200±5% rpm). Accordingly, it can be seen that the power of the car becomes better.

### INDUSTRIAL APPLICABILITY

As described above, in the air cooler type apparatus of removing impurities from oil according to the present invention, water (H₂O), particle materials (PM), sulfur (s) or the like, which are unnecessary mixture in oil, are separated and removed from the oil to furnish oil of high quality, whereby the exhaust gas can be remarkably decreased.

Although preferred embodiments of the present invention have been described for illustrative purposes, those skilled in the art will appreciate that various modifications, additions and substitutions are possible, without departing from the scope and spirit of the invention as disclosed in the accompanying claims

1. An air cooler type apparatus of removing impurities from oil comprising:
a body having an enclosed space for storing oil;
a cool air injecting portion formed at a upper portion of the body and for injecting an air, which is cooled at a predetermined temperature corresponding to a temperature of the oil stored in the body, into an inside of the body;
an absorption means mounted on a supporting structure of absorption means mounted to a lower portion of the body and for absorbing the impurities, which are deposited by descending a temperature owing to the injected air through the cool air injecting portion;
a separating and discharging portion formed at one side of the body and above the absorption means and for separating and collecting the oil, in which the impurities are removed; and
an impurity discharging portion formed at a lower end portion of the body and for discharging the impurities, which are deposited by descending temperature owing to the injected air through the cool air injecting portion and are not absorbed in the absorption means, to an outside thereof.

2. An air cooler type apparatus of removing impurities from oil as claimed in claim 1, further comprising an underground oil settling tank connected to one side of the body through a coupling pipe, wherein the oil is deposited in the settling tank for a predetermined time and flows into the body.

3. An air cooler type apparatus of removing impurities from oil as claimed in claim 1, further comprising a grating portion mounted between the a separating and discharging portion and the absorption means and an oil injecting portion for washing located at the upper portion of the body and for injecting the oil for washing into the inside of the body, wherein an outer surface of the body is packed with a material for keeping coolness in order to be insulated from an outside thereof.

4. An air cooler type apparatus of removing impurities from oil as claimed in claim 1, wherein the air of the cool air injecting portion filtered below 30% in humidity is cooled at 1° C.-5° C. and is injected into the inside of the body for 6-12 hours.
